(19) United States
(12) Patent Application Publication
(10) Pub. No.: US 2008/0185812 A1
(43) Pub. Date: Aug. 7, 2008

(54) Collapsible bicycle

(76) Inventor: Chin-Chi Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/701,493

(22) Filed: Feb. 2, 2007

(51) Int. Cl. B62K 15/00

(52) U.S. Cl. 280/278

(57) ABSTRACT

A collapsible bicycle includes a handlebar, a tubular portion, a front wheel portion, a saddle portion, a first frame, a second frame, a rear wheel portion, and supporting coasters. The saddle portion has a rod body. The rod body is fixed obliquely on one end of the second frame, and the other end of the second frame is rotatably pivoted on the tubular portion. One end of the first frame is rotatably pivoted with a clamping element on the tubular portion, and a middle portion of the second frame is rotatably pivoted on a middle portion of the first frame. A supporting element extends from the end of the first frame near the rear wheel portion allowing supporting the collapsible bicycle.

### BACKGROUND OF THE INVENTION

1. Field of the Invention

The present invention relates to a collapsible bicycle, and particularly relates to its ease of folding method and agile mobility in a collapsed mode.

2. Description of the Related Art

Bicycles are more and more popular in recent years because of its convenience and ability to provide exercise and transportation means for riders. Moreover, bicycling has become an increasingly popular form of recreation. Whether the bicycle is used for recreation, transportation or sports competition. The industry is constantly improving the bicycle structure as well as its components. Bicycle structure becomes lighter and less expensive while maintaining a high level of performance.

In the recent years, folding bicycles are designed to save storing space as well as ease to move around places. However, folding a bike properly and neatly is not an easy job; it often requires skillful technical back grounds. Further more, to move it around after folding needs a third transportation mean or much labor and heavy load.

Furthermore, there is no supporting mechanism on the bicycle when it's folded. Hence, it is very difficult to move to its next destination or simply move around in places where riding is difficult or not permitted at all.

### SUMMARY OF THE INVENTION

The primary object of the present invention is to provide a collapsible bicycle that is user friendly in folding and easy to move around to next destination or simply to places where riding is difficult or not permitted at all. The effort needed to fold and unfold the bicycle is minimal, even small kids can do it easily, unlike the heavy and difficult labor work in all the present constructions.

Another point of the present invention is that pedals can also be folded to reduce the size of the bicycle and increase it's mobility in collapsed mode.

In accordance with these objectives, a clamping element according to the present invention is adapted to make an end of a first frame slide on a tubular portion. By sliding the end of the first frame, the position of a rear wheel portion connected to the other end of the first frame is adjusted relative to the position of a front wheel portion to form a collapsed mode or a normal riding mode. In a collapsed mode, the front wheel portion and supporting coasters are on the ground and the handlebar is readily to turn in directions and to tow the collapsed bicycle following the user easily.

In order to enable the bicycle to stand on it's own in collapsed mode, two supporting coasters are mounted onto the rear wheel. These supporting coasters will be lifted and not be obstacle when bicycle is in normal riding situation.

The pedals of the bicycle can also be folded into a locked portion, to reduce overall size of the bicycle when collapsed to increase the mobility and save more space in storing.

It is to be understood that both the foregoing general description and the following detail description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a schematic view of a collapsible bicycle in normal riding mode;

FIG. 2 is a schematic view of a collapsible bicycle in collapsed mode according to present invention;

FIG. 3 is a schematic view for turning handlebar of a collapsible bicycle in collapsed mode according present invention;

FIG. 4 is a schematic back-view of a collapsible bicycle in collapsed mode according present invention;

FIG. 5A is a schematic view of a pedal of a collapsible bicycle according to present invention;

FIG. 5B is a schematic view of a pedal of a collapsible bicycle according to present invention; and

FIG. 5C is a schematic view of a folded pedal of a collapsible bicycle according to present invention.

### DETAILED DESCRIPTION OF THE PREFERRED EMBODIMENTS

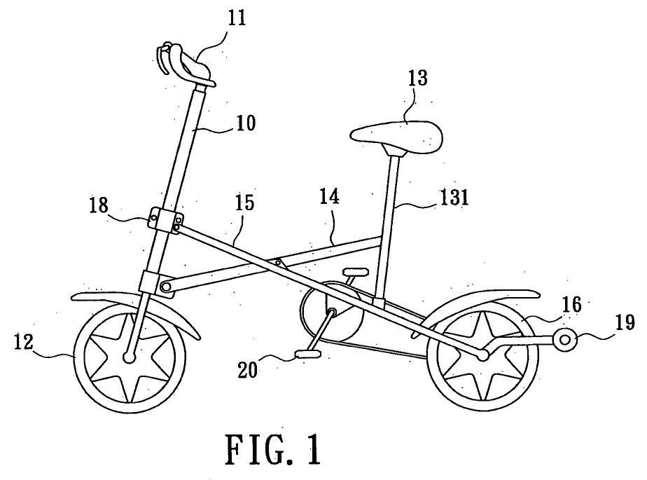

Referring to FIG. 1, the embodiment of the present invention provides a collapsible bicycle in a normal riding mode. The collapsible bicycle includes: a tubular portion 10, a handlebar 11, a front wheel portion 12, a saddle portion 13, a first frame 15, a second frame 14, a rear wheel portion 16, a clamping element 18, a supporting coaster 19, and a pair of foldable pedals 20. The handlebar 11 is extended downwardly to penetrate through the tubular portion 10 and, to this end, connected to the front wheel portion 12. The saddle portion 13 has a rod body 131 fixed obliquely on one end of the second frame 14. The other end of the second frame 14 is rotatably pivoted on the tubular portion 10. One end of the first frame 15 is rotatably pivoted with a clamping element 18 on the tubular portion 10. A middle portion of the first frame 15 is rotatably pivoted on a middle portion of the second frame 14. Furthermore, the rear wheel portion 16 is disposed on the other end of the first frame 15. A supporting coaster 19 extends from an end of the first frame 15 and one end of the supporting coaster 19 is preferably having a circular wheel. When a rider (not shown) is riding the collapsible bicycle, the supporting coaster 19 is lifted above the ground and takes no effect in a normal riding.

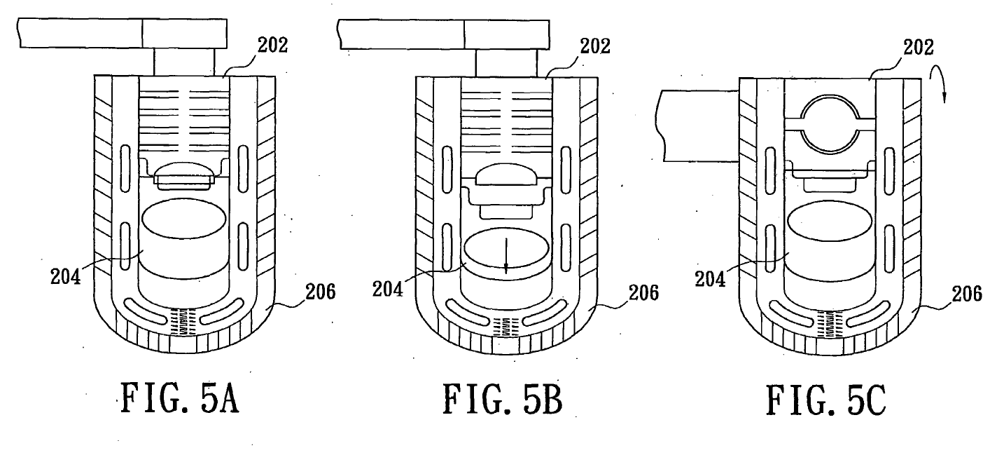

Moreover, the collapsible bicycle further includes a pair of foldable pedals 20. Please refer to FIG. 5A-5C; each foldable pedal 20 includes a fixed portion 202, a locked portion 204, and a folded portion 206. The folded portion 206 is pivoted on the fixed portion 202 and the locked portion 204 movably abuts against the fixed portion 202. The folded portion 206 can be folded by extracting the locked portion 204 from the fixed portion 202 and rotating the folded portion 206. Then, the folded portion 206 can be folded and fixed on the predetermined position by bucking the locked portion 204 on the fixed portion 202.

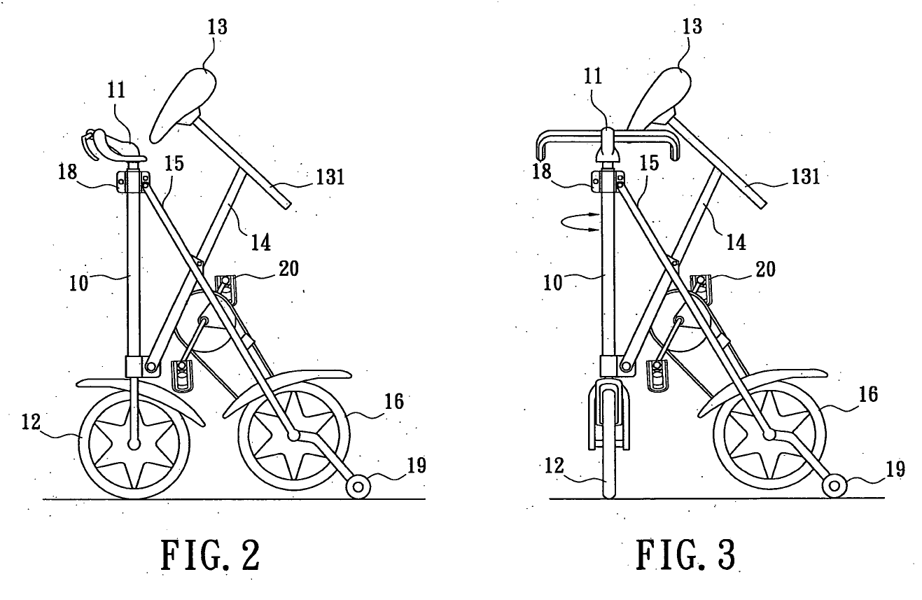

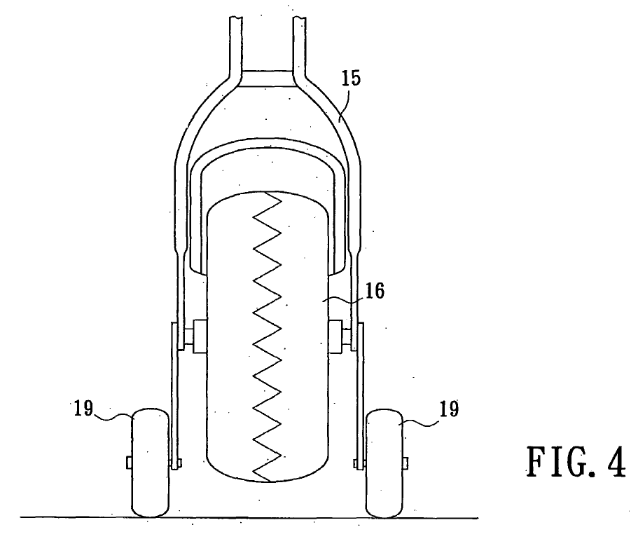

Referring to FIGS. 2-4, a rider (not shown) using the clamping element 18 to slide the first frame 15 upwardly closing to the upper end of the handlebar 11. With the slide of the first frame 15, the rear wheel portion 16 moves toward the front wheel portion 12 and the supporting coaster 19 contacts with the ground to form a collapsed mode. In the collapsed mode, the front wheel portion 12 and the supporting coaster 19 are on the ground and the user (not shown) can control the handlebar 11 to turn in directions as shown in FIG. 3 and to tow the folded bicycle following the user labor savingly. Meanwhile, referring to FIG. 4, the supporting coaster 19 is set on the both side of the bicycle to support the collapsible bicycle in the collapsed mode. One end of the supporting coaster 19 is preferably having a circular wheel.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A collapsible bicycle, comprising a handlebar extending downwardly to penetrate through a tubular portion, a front wheel portion connected to a end of the handlebar, a saddle portion having a rod body, a first frame, a second frame, a pair of folded pedals, and a rear wheel portion connected to a end of the second frame;
wherein the rod body is fixed obliquely on one end of the second frame and the other end of the second frame is rotatably pivoted on the tubular portion;
wherein one end of the first frame is rotatably pivoted with a clamping element on the tubular portion, and a middle portion of the second frame is rotatably pivoted on a middle portion of the first frame;
Characterized in that a supporting coaster extends from the end of the first frame near the rear wheel portion.

2. The collapsible bicycle as claimed in claim 1, wherein each of the folded pedals further comprises a folded portion pivoted on a fixed portion, a locked portion movably abutting against the fixed portion.

3. The collapsible bicycle as claimed in claim 1, wherein the clamping element slides toward an upper end of the handlebar to move the rear wheel portion toward the front wheel portion.

4. The collapsible bicycle as claimed in claim 3, wherein the supporting element is set on both side of the collapsible bicycle.

5. The collapsible bicycle as claimed in claim 3, wherein the handlebar rotates in directions.
